(19) United States
(12) Patent Application Publication
(10) Pub. No.: US 2006/0222316 A1
(43) Pub. Date: Oct. 5, 2006

(54) Time shift actuation and control method used for personal video recorder

(76) Inventors: Shih-Hsiung Weng, Taipei City (TW); Sin-Poh Then, Penang (MY)

Correspondence Address: RABIN & BERDO, P.C.;Suite 500, 1101 14 Street, N.W., Washington, DC, 20005, US

(21) Appl. No.: 11/097,305

(22) Filed: Apr. 4, 2005

(51) Int. Cl. H04N 5/91

(52) U.S. Cl. 386/46

(57) ABSTRACT

A time shift actuation and control method used for a personal video recorder (PVR), comprises the following steps: receiving an infrared interrupt signal; upon verifying that it is a time shift signal, determining the time shift function relating to said PVR, if said time shift function has already been initialized, the said PVR enters into the time shift mode, then performing the corresponding functions according to the different information contained in the infrared interrupt signal, comprising the playing back of the presently played program in one of the following manners: normal speed, slow motion, fast forward, reverse, pause, and stop.

### BACKGROUND

1. Field of the Invention

The invention relates to a time shift actuation and control method and in particular to the time shift actuation and control method used for a personal video recorder.

2. Related Art

Presently, the cable TV system is going through a major transition period from the conventional analog TV system to the more advanced digital TV system. In the newly developed digital TV system, the user is provided with the capability to view the TV programs in various manners at his/her own choice. This is not provided by the conventional TV system. As such, a personalized TV service is apparently the tendency and the mainstay of the future TV service. However, before the conventional TV system is entirely phased out and replaced by the cable TV system, the so-called Set-Top-Box (STB) (which is actually a digital address decoder) could be the crux of TV system operation during this transition period. Upon connecting to the video converter (i.e. the so-called STB), the conventional TV, which originally is only capable of receiving analog signals, is thus enabled to receive the digital signals for providing the desired images of the program on the screen by making use of STB. As such, with the cooperation of the TV service program providers, the user is enabled to view the programs of his/her own choice with the digital TV. At the present stage, the technical development of the hard disk is essential to the implementation of the video converter (STB) technology. Only through design and functions of the video converter built in the hard disk drive can the functions of the personal video recorder (PVR) be realized. Right now, the provision of the PVR function is the major reason for the users to utilize a hard disk drive having a built-in video converter. The PVR function is used to provide the cable TV viewers with the capability of directly controlling the program selection and managing the large number of channels provided by the digital TV system, such that the length of the TV program recorded may be varied depending on the size and the capacity of the attached hard disk.

At present, the major functions of the personal video recorder (PVR) of the prior art include: the program recording and the program time-shift viewing. While the time-shift viewing feature is probably the most prominent and important feature of the PVR of the prior art, which may be utilized to temporarily stop the presently played program and instantly replay the recorded program that has just been played previously. When executing the computer programs relating to these time-shift functions, the contents of the presently played programs can be stored temporarily in the hard disk, so that the programs that has just been played previously can be played back instantly by retrieving it from the hard disk and may be with certain specific sections skipped, so that the user may view and enjoy repeatedly any section of the programs just played previously at his/her own choice.

However, at present, the time-shift function provided by the personal video recorder (PVR) does not include the functions of REVERSE, FAST FORWARD, and SLOWMOTION as provided by the tape recorder-player. Therefore, it is very desirable that the PVR is also capable of providing the functions of REVERSE, FAST FORWARD, and SLOWMOTION as provided by the tape recorder player.

### SUMMARY

In view of the above-mentioned problems and shortcomings of the prior art, the object of the invention is to provide a time shift actuation and control method used for a PVR or Set-Top-Box, which can be utilized to facilitate the user to record and reverse the presently played programs, so as to overcome and improve the shortcomings and the limitations of the prior art. Thus, the invention provides such a method so that the user is enabled to: actuate the various functions of Reverse, play, Fast Forward, and Slow Motion; enter into the “time shift mode” of the PVR merely by a simple touch of the key; replay certain sections of the program that has just been played and recorded previously without interrupting the recording of the presently played program; switch between the presently played program and sections of the program that has just been recorded previously merely by a simple touch of the key according to his/her own choice.

To achieve the objectives of the invention, the invention provides a time shift actuation and control method used for a personal video recorder (PVR), which mainly comprises: a microprocessor, a timer, an input/output port, a flash memory (FLASH)/electrically erasable read only memory (EEROM), a random access memory (RAM), a read only memory (ROM), a hard disk drive (HDD) and an infra-red (IR) receiver module. The functions of all these devices will be described in detail in the following preferred embodiment.

Therefore, in order to achieve the objective of the invention, the invention provides a time shift actuation and control method used for a personal video recorder, comprising the following steps: firstly, detecting an infrared interrupt signal and receiving the infrared interrupt signal. Next, identifying the time-shift functions contained in the signal, upon determining that said infrared interrupt signal is a time shift signal. Then, certifying the conditions of the corresponding time shift functions of the PVR. If its time shift function has already been actuated, entering into the time-shift mode of the PVR. Finally, executing the various time shift functions for the presently played program as specified in said received signals including: instant replay, instant slow-motion replay, instant fast-forward replay, instant revise replay, instant pause replay, and instant stop replay.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given below, which is for illustration only and thus is not limitative of the present invention, wherein:

FIG. 1 is a system structure block diagram of the personal video recorder (Set-Top-Box) utilized in the invention;

FIG. 2 is a flowchart illustrating the receiving and detection of the infrared interrupt signal from the PVR remote controller to determine whether to actuate the time-shift mode of the PVR according to the embodiment of the invention;

FIG. 3 is a flowchart illustrating the process flow following the actuation of the time-shift mode according to the embodiment of the invention;

FIG. 4 is a flowchart illustrating the process flow following the stop of the time-shift mode according to the embodiment of the invention; and

FIG. 5 is a flowchart illustrating the process flow following entering into the trick mode according to the embodiment of the invention.

### DETAILED DESCRIPTION

The purpose, construction, features, and functions of the present invention can be appreciated and understood more thoroughly through the following detailed description with reference to the attached drawings.

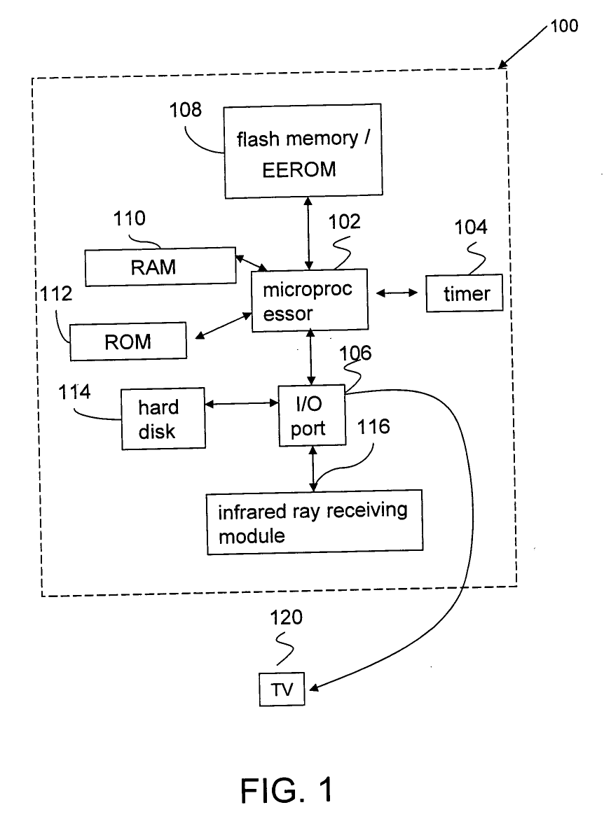

Firstly, refer to FIG. 1 for the system structure block diagram of the Personal Video Recorder (PVR) utilized in the invention. As shown in FIG. 1, the Personal Video Recorder (PVR) 100 utilized in the invention comprises a microprocessor 102, a flash memory (FLASH)/electrically erasable ROM 108, used for storing data and erasing the stored data, a read only memory (ROM) 112, used for permanently storing the data or codes; a timer 104, used for timing, and an input/output (I/O) port 106, used as the interface between the PVR and the peripheral devices. The I/O port 106 is connected to the hard disk drive (HDD) 114, infrared (IR) receiver module 116, and a TV set 120. Among them, the hard disk drive (HDD) 114 is a memory device, used to store large amount of data, while the IR receiver module 116 is used to receive the IR signal generated by the remote controller of the PVR.

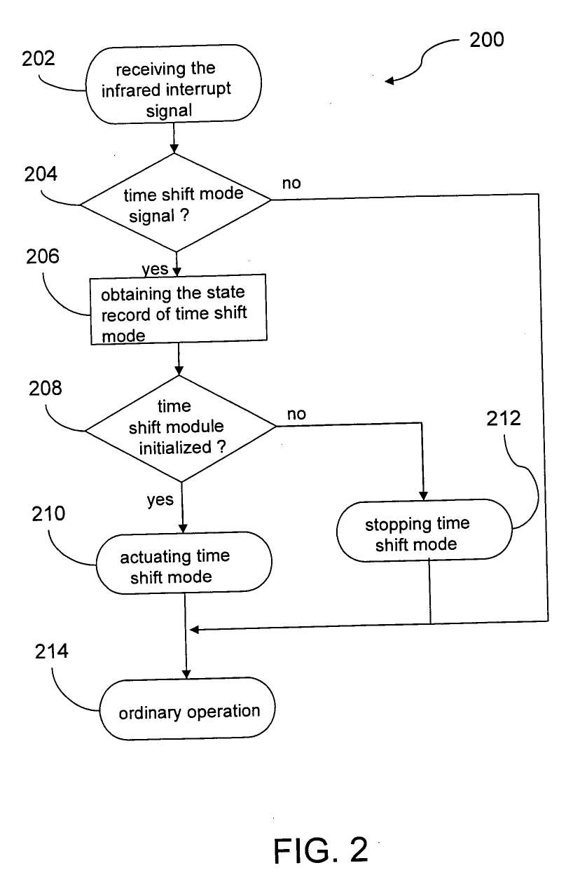

Through the connection of these devices, the images and the sounds of the digital signals are converted into those of the analogue signals to be input to the conventional analog TV and played on the screen. However, if the TV utilized by the user is a digital TV, then such a signal conversion process is not required. For the purpose of the invention, a time-shift control button is provided on the PVR remote controller, which is used to enable the user to actuate the related time-shift function just by pressing a specific key. The microprocessor 102 is utilized as the central processor unit (CPU) for controlling and coordinating the functions and operations of all the modules in the PVR, thus ensuring the smooth and proper function between/among them. The read only memory (ROM) 112 is used to store the instruction codes, which are used by the microprocessor 102 to read or write data in the specific region of the I/O port, as such, to read or change the condition of said output port. Wherein the sequence of the codes corresponds to the functional steps of the operation flow of the method, including: the detection of the infrared interrupt signal, which is used to determine whether to actuate the steps of the time-shift mode; actuating the time-shift mode; stopping the time-shift mode, or executing the trick mode. The details of all of these modes will be described more thoroughly in the following, in conjunction with FIGS. 2, 3, 4, and 5 respectively.

In the following description, for easy explanation and understanding, the system flows of the method of the invention are broken down into various process flows and referred to as process flows 200, 300, 400, and 500 in FIGS. 2, 3, 4, and 5 respectively.

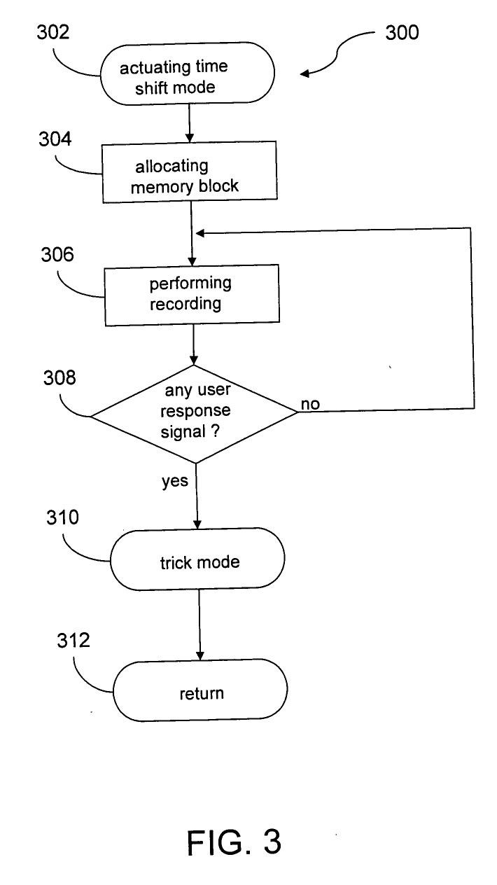

Firstly, please refer to FIG. 2 for the flowchart illustrating the receiving and detection of the infrared interrupt signal from the PVR remote controller to determine whether to actuate the time-shift mode of the PVR according to the embodiment of the invention. Firstly, upon receiving the infrared interrupt signal (step 202), starting to proceed the process flow 200, thus when a certain key of the time-shift modes on the PVR remote controller is pressed, a specific infrared interrupt signal 202 is generated, then the process flow proceeds to step 204. At this time, the microprocessor is used to determine if the infrared interrupt signal is derived from the remote controller by pressing a specific time-shift key thereon, if this is not the case, the microprocessor will exit from the process flow and return to the ordinary operation of the PVR system (step 214), which includes the operation process that may generate the infrared interrupt signal. However, if it is determined that the infrared interrupt signal is derived from a specific time-shift key (step 204), then the process flow proceeds to step 206, the microprocessor is used to obtain the information of the present condition in the time-shift record of the PVR (step 206), and determine whether the present condition of the time-shift record is valid (step 208) or whether the time-shift function of the PVR has already been initialized. If either one of the above conditions is valid, then the process flow proceeds to step 210. At this time the microprocessor is used to actuate the process flow of the time-shift mode (step 210), the details of the process flow following the time-shift mode will be described below in conjunction with FIG. 3. Subsequently, if the condition of the time-shift record at this time is invalid, then the process flow proceeds to step 212, the microprocessor stops the proceeding of the time-shift mode and returns to the ordinary operation of step 214.

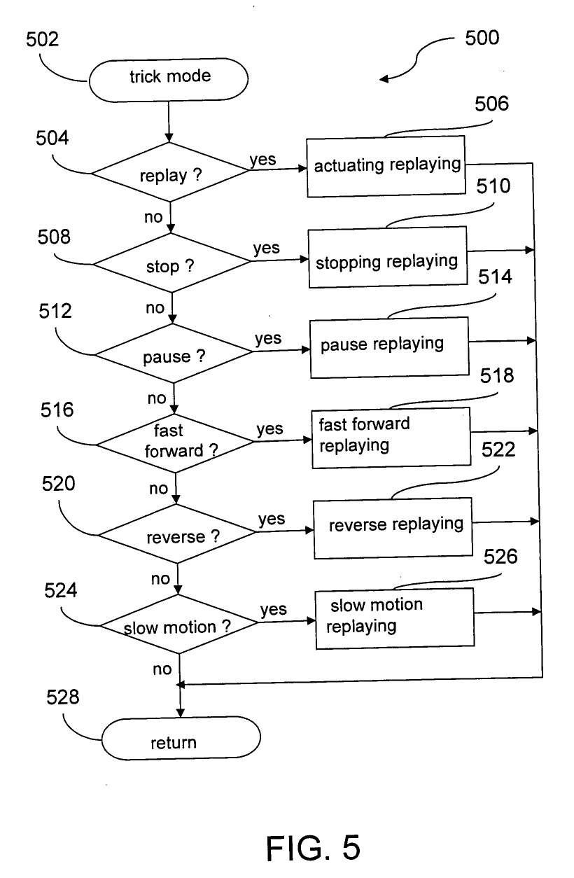

Next, refer to FIG. 3 for the flowchart illustrating the process flow following the actuation of the time-shift mode according to the embodiment of the invention. As shown in FIG. 3, when it is determined by the microprocessor in FIG. 2 that the present time shift state of the PVR is valid or the time shift function of the PVR has already been initialized (step 208) as described in FIG. 2, then the system flow of the PVR continues in the process flow 300 of FIG. 3 with its starting step 302. In which, firstly, the microprocessor is used to actuate the time shift mode. Next, the microprocessor is used to allocate certain portions of the memory blocks in the memory pool for temporarily storing the recorded presently played programs (step 304). As such, the microprocessor is used to start recording the presently played program (step 306). Subsequently, the microprocessor enters into a waiting loop to wait for the user's response signals (step 308), and continuously detects the user's response signals. If it does not receive any user's response signals, then the microprocessor is used to continue proceeding the loop starting from step 306, namely, continuously recording the presently played program until it detects the user's response signal. However, if in step 308 the microprocessor detects the receiving of response signal generated by the PVR remote controller because the user is pressing one of its specific control keys, then the microprocessor enters into the process flow of the trick mode (step 310), which will be described in detail in FIG. 5. Finally, the process flow proceeds to step 312, the microprocessor is showing exits from the process flow 400 and returns to the process flow 200 of FIG. 2 as mentioned earlier.

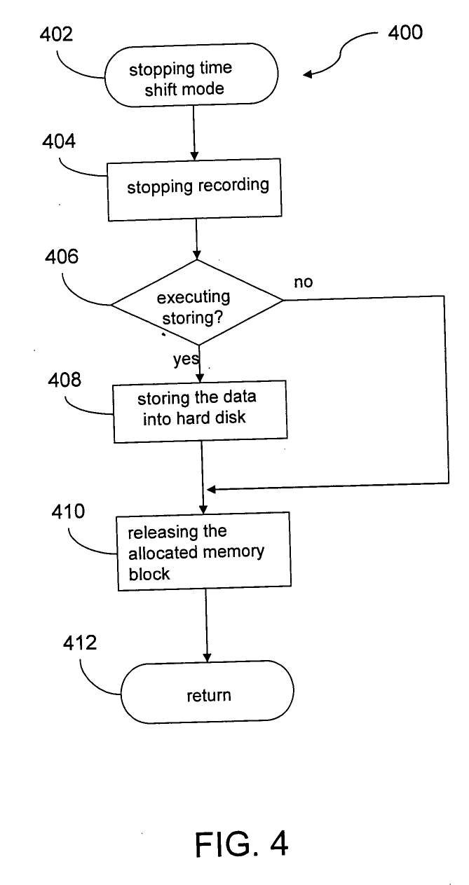

Subsequently, refer to FIG. 4 for the flowchart illustrating the process flow following the stop of the time-shift mode according to the embodiment of the invention. As shown in FIG. 4, when it is determined by the microprocessor in step 208 of FIG. 2 that the condition of the identified time shift record is not valid, then the system flow of the PVR enters into the process flow 400. Firstly, the process flow 400 starts at step 402, wherein the microprocessor is used to stop the process flow of the time shift mode. Next, in step 404, the microprocessor is utilized to stop recording the presently played program. Then, the microprocessor is used to determine whether to store the recorded program section (step 406). If the user chooses to do so, then the recorded program section is stored in the hard disk drive, having large storage capacity by the microprocessor (step 408). However, the allocated memory blocks will be released by the microprocessor, regardless whether the recorded program section is to be stored (step 410) or not. The memory block allocation is done in step 304 of the process flow 300 as shown previously in FIG. 3, thus the released memory blocks may be utilized later in other operations. As such, the microprocessor exits from the process flow and the system flow returns to the process flow 200 of FIG. 2 (step 412).

Finally, refer to FIG. 5 for the flowchart illustrating the process flows following entering into the trick mode according to the embodiment of the invention.

As shown in FIG. 5, when the microprocessor in step 308 of FIG. 3 detects the response signal of the user, the system flow of the PVR enters this process flow 500. To begin with, the process flow begins at step 502, thus the microprocessor enters into the trick mode. Next, the microprocessor is used to identify and determine through the infrared (IR) interrupt signal. The key of the PVR is pressed by the user, to proceed with the pertinent step in this process flow. At this time, it is crucial to determine whether the key pressed by the user on the remote controller of the PVR is the REPLAY BUTTON (step 504). If so, the microprocessor is used to replay the program section that has just been recorded previously according to the manner as described in Fig. (step 506). As such, the user is able to view the program section he might have missed previously or desires to view again, while the recording of the presently played program is still in progress. However, if the key of the remote controller pressed by the user in step 504 is not the REPLAY BUTTON, then it is determined whether the key pressed by the user is the STOP BUTTON (step 508). If so, the microprocessor is instructed to stop replaying the recorded program sections that have been played previously (step 510). Thus the user may go back to watch the presently played program, while the recording of the presently played program is still in progress. However, if the key of the remote controller pressed by the user in step 508 is not the STOP BUTTON, then it is determined whether the key pressed by the user is the PAUSE BUTTON (step 512). If so the process flow is proceeded to step 514, and the microprocessor is instructed to pause replaying the recorded program section that has been played previously (step 514), while the recording of the presently played program is still in progress. However, if the key of the remote controller pressed by the user in the step 512 is not the PAUSE BUTTON, it is determined whether the key pressed by the user is the FAST FORWARD BUTTON (step 516). If it so, the process flow proceeds to step 518. The microprocessor is instructed to fast forward replaying the recorded program section that has been played previously in a fast forwardly manner (step 518), thus the user is enabled to follow closely the presently played program, while the recording of the presently played program is still in progress. However, if the key of the remote controller pressed by the user in step 516 is not the FAST FORWARD BUTTON, then it is determined whether the pressed key is the REVERSE BUTTON (step 520). If so, the process flow proceeds to step 522, and the microprocessor is instructed to reverse playing the recorded program section that has been played previously (step 522), thus the user is enabled to find the program position desired to reach and to view, while the recording of the presently played program is still in progress. However, if the key of the remote controller pressed by the user at step 520 is not the REVERSE BUTTON, then it is determined whether the key pressed by the user is the SLOW MOTION BUTTON (step 524). If so, the process flow proceeds to step 526, and the microprocessor is instructed to play the recorded program sections that have been played previously in a slow motion manner (step 526), thus the user is enabled to view more clearly the previously played program section without any omission, while the recording of the presently played program is still in progress. However, if the key of the PVR remote controller pressed by the user is not the SLOW MOTION BUTTON in step 524, the process flow proceeds to step 528, and the microprocessor is instructed to exit this process flow 500, thus the system flow returns to the process flow 300 of FIG. 3 (step 528).

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

What is claimed is:

1. A time shift actuation and control method used for the personal video recorder (PVR), comprising the following steps:
receiving an infrared (IR) interrupt signal;
retrieving the time shift state of said personal video recorder, upon verifying that said infrared interrupt signal is a time shift mode signal;
obtaining a time-shift-initialization signal according to said time shift state; and
actuating the time shift mode of PVR according to said time-shift-initiation signal.

2. The time shift actuation and control method of claim 1, further comprising:
following actuating the time shift mode, allocating a memory block for temporarily storing the presently played program in said memory block; and
upon receiving a replay signal, retrieving from said memory block the recorded program thus to replay the program that had just been played previously.

3. The time shift actuation and control method of claim 2, further comprising: following playing back said program that had just been played previously, receiving a stop replay signal, thus to stop playing back said recorded program that had just been played previously.

4. The time shift actuation and control method of claim 2, further comprising: following playing back said program that had just been played previously, receiving a pause signal thus to pause playing back said recorded program that had just been played previously.

5. The time shift actuation and control method of claim 2, further comprising: following playing back said program that had just been played previously, receiving a fast-forward signal thus to play back said recorded program that had just been played previously in a fast forwardly manner.

6. The time shift actuation and control method of claim 2, further comprising: following playing back said program that had just been played previously, receiving a reverse signal thus to play back said recorded program that had just been played previously in a rewinding manner

7. The time shift actuation and control method of claim 2, further comprising: following playing back said program that had just been played previously, receiving a slow-motion signal thus to play back said recorded program that had just been played previously in a slow motion manner.

8. The time shift actuation and control method of claim 2, further comprising:
obtaining a time-shift-not-initialized signal according to said time shift state;
stopping recording said presently played program according to said time-shift-not-initialized signal, and upon receiving a storage signal, storing said recorded presently played program into the hard disk; and
releasing said memory blocks used for temporarily storing said recorded presently played program.
